(19) United States
(12) Patent Application Publication
(10) Pub. No.: US 2006/0250416 A1
(43) Pub. Date: Nov. 9, 2006

(54) Audio reproduction method and device

(75) Inventor: Kouichi Matsuda, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: SONY CORPORATION, TOKYO (JP)

(21) Appl. No.: 10/563,768

(22) PCT Filed: Jul. 21, 2004
(86) PCT No.: PCT/JP04/10690

§ 371 Date: Jan. 9, 2006

(30) Foreign Application Priority Data
Jul. 25, 2003 (JP) 2003-280309

(51) Int. Cl. G09G 5/00

(52) U.S. Cl. 345/619

(57) ABSTRACT

When reproducing audio data to which character data for displaying a character having a specific shape is added, the character data is analyzed to generate data on an image having the shape specified by the character data and to display the image correspondingly to the reproduction of the audio data. In addition, when motion data for indicating motion of the character having the shape specified by the character data is added, the motion indicated by the motion data is displayed correspondingly to the reproduction of the audio data. Further, based on a predetermined input operation, the character having a three-dimensional, shape seen from an arbitrary viewpoint is displayed.

### TECHNICAL FIELD

The present invention relates to an audio reproduction method and apparatus for reproducing audio data stored in some medium or audio data downloaded, for example.

### BACKGROUND ART

A conventional audio reproduction apparatus such as a stereo reproduction apparatus is designed for processing to reproduce audio data recorded in a recording medium such as an installed CD (compact disc) and MD (mini disc), or audio data received from the outside. On this occasion, there are cases where the following visual display processing is performed in a reproduction apparatus at the time of reproduction, that is, for example, a display panel is provided as a spectrum analyzer for displaying a level variation and the like, of every bandwidth analyzed in the spectrum analyzer, in music under reproduction.

Published Japanese Patent Application No. H8-130425 issued from Japanese Patent Office discloses the display of a spectrum analyzer in audio equipment.

Hereupon, the display according to a spectrum analyzer and the like in the past only indicates data characteristics of reproduced music and the like, and so there is a problem that information associated with data on the music is not displayed positively. In other words, it is difficult for the display in conventional reproduction apparatus of this type to display motion associated with the music under reproduction or to display a character of singer of the music.

In order to solve this problem, it is conceived, for example, to prepare a medium capable of recording image data such as DVD (Digital Video Disc or Digital Versatile Disc), in which the image data is recorded together with audio data, and to display the image based on that image data at the time of reproducing audio data, however, such image data has a large data volume, and if such image data is handled in a typical audio reproduction apparatus, a heavy burden will be imposed thereon, which raises another problem.

The present invention has been made in view of these points and aims at enabling the image attached to the audio to be displayed comparatively with ease.

### DISCLOSURE OF INVENTION

A first aspect of the present invention is an audio reproduction method when reproducing audio data to which character data for displaying a character having a specific shape is added, the method including the steps of: generating data on an image having the shape specified by the character data by analyzing the character data, and displaying the generated image data correspondingly to the reproduction of said audio data.

By doing in this way, the character corresponding to the audio reproduction will be displayed at the time of audio reproduction, in which display can be performed correspondingly to the audio in a smaller data volume as compared with a case where moving image data is separately prepared.

A second aspect of the present invention is an audio reproduction method according to the first aspect of the present invention, wherein when motion data indicating motion of the character having the shape specified by the character data is added, the motion indicated by the motion data is displayed correspondingly to the reproduction of audio data.

By doing in this way, the character's motion linked with the audio reproduction can be displayed and, for example, choreography corresponding to music and the like can be known from the motion of the displayed character.

A third aspect of the present invention is an audio reproduction method according to the first aspect of the present invention, wherein the character data are data showing a character of a three-dimensional shape and based on a predetermined input operation the character to be displayed is made into a character having a shape seen from an arbitrary viewpoint.

By doing so, the character seen from an arbitrary direction can be displayed based on the operation of the user, and the character can be displayed in the form preferable for the user.

A fourth aspect of the present invention is an audio reproduction apparatus including: retaining means for retaining audio data to which character data for displaying a character having a specific shape is added, audio reproduction means for processing to reproduce the audio data retained in the retaining means, image processing means for generating data on an image having the shape specified by the character data by analyzing the character when character data is added to the audio data reproduced in said audio reproducing means, and display means for displaying the image data generated in the image processing means correspondingly to the reproduction in audio reproduction means.

By doing in this way, the character corresponding to the audio reproduction is displayed at the time of audio reproduction, and so such an audio reproduction apparatus is obtained that the display corresponding to the audio can be performed in a smaller data volume as compared with the case where moving image data is prepared separately.

A fifth aspect of the present invention is an audio reproduction apparatus according to the fourth aspect of the present invention, wherein motion data for indicating motion of the character having the shape specified by the character data is further added to the audio data retained in the retaining means, and the image processing means generates an image in which the motion indicated by the motion data is added to the character specified by the character data.

By doing so, the character whose move is linked with the audio reproduction can be displayed and, for example, choreography corresponding to music and the like can be known from the motion of the displayed character.

A sixth aspect of the present invention is an audio reproduction apparatus according to the fourth aspect of the present invention, wherein the character data added to the audio data retained in the retaining means is data on a character having a three-dimensional shape, operating means for indicating a viewpoint toward the character having a three-dimensional shape is provided, and based on the viewpoint indicated by the operating means, the image data generated in the image processing means is made into an image of the character seen from the view point.

By doing so, the character seen from an arbitrary direction can be displayed based on user's operation and the character can be displayed in the form preferable for the user.

### BRIEF DESCRIPTION OF DRAWINGS

FIG. 1 is a block diagram showing an example of a system configuration according to an embodiment of the present invention;

FIG. 2 is an explanatory diagram showing an example of a hierarchic structure for reproduction processing according to an embodiment of the present invention;

FIG. 3 is a flowchart showing an example of data processing according to an embodiment of the present invention;

FIG. 4 is an explanatory diagram showing an example of a processing state according to an embodiment of the present invention;

FIG. 5 is an explanatory diagram showing an example of display according to an embodiment of the present invention; and

FIG. 6 is an explanatory diagram showing an example of data according to an embodiment of the present invention.

### BEST MODE FOR CARRYING OUT THE INVENTION

Hereinafter, an embodiment according to the present invention will be described with reference to accompanying drawings.

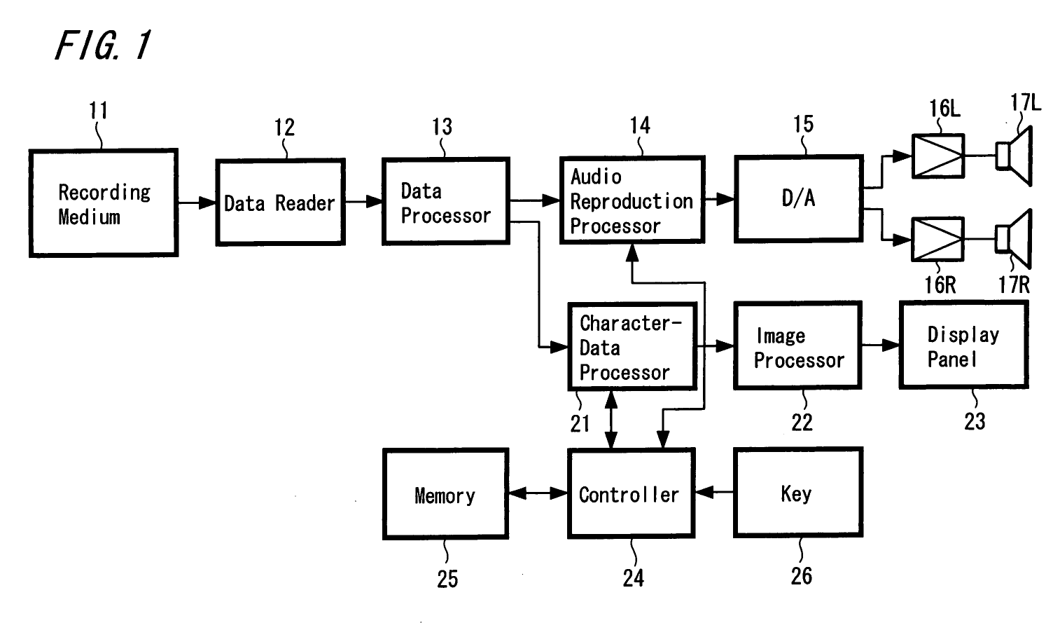

FIG. 1 shows an example of a configuration of an audio reproduction apparatus in this embodiment. In case of this example, it is designed that a recording medium 11 for recording audio data is installed in the reproduction apparatus. The recording medium 11 may be, for example, an optical disc or magneto-optical disc such as a CD and MD in which digital audio data is recorded, or various kinds of memory card. In addition, a semiconductor memory, hard disc and the like incorporated in the reproduction apparatus may be employed in which audio data downloaded from the outside is recorded. In this example, it is arranged that character data formed of data on a shape expressing some object is added to the audio data recorded in the recording medium 11. A specific example of the character data will be described later on.

The audio data recorded in the recording medium 11 is read out by a data reader 12. When there is data such as the character data added to the audio data, the added data is also read out by the data reader 12 at the same time. The readout data is supplied to a data processor 13, where data processing such as error correction is performed, after that, the audio data is supplied to an audio reproduction processor 14, where audio reproduction processing is performed. The reproduction audio data processed in the audio reproduction processor 14 is supplied to a digital/analog converter 15 and is converted into analog audio signals of a right channel and left channel, and a converted analog audio signal of each channel is amplified by amplifiers 16L, 16R and then is supplied to speakers 17L, 17R for respective channels to be output.

The character data read out together with audio data by the data reader 12 is separated from the audio data by the data processor 13 and supplied to a character-data processor 21. The character-data processor 21 determines contents of the character data to generate data for displaying an image having the shape specified by the character data, and the generated image data is supplied to an image processor 22 and is made into image data of a predetermined format, which is supplied to a display panel 23 to be displayed thereon. When a display device is, for example, incorporated in the reproduction apparatus, a liquid crystal display panel or the like can be applied as the display panel 23.

Audio processing by the audio processor 14, character processing by the character-data processor 21 and the like are performed under the control of a controller 24 which is a central control unit. A memory 25 storing a control program and the like is connected to the controller 24. Further, it is configured that the controller 24 receives instructions by operation of an operating key 26. In case of this example, possible operation by the operating key 26 includes operation for determining a viewpoint of the displayed character as well as operation related to the reproduction of audio.

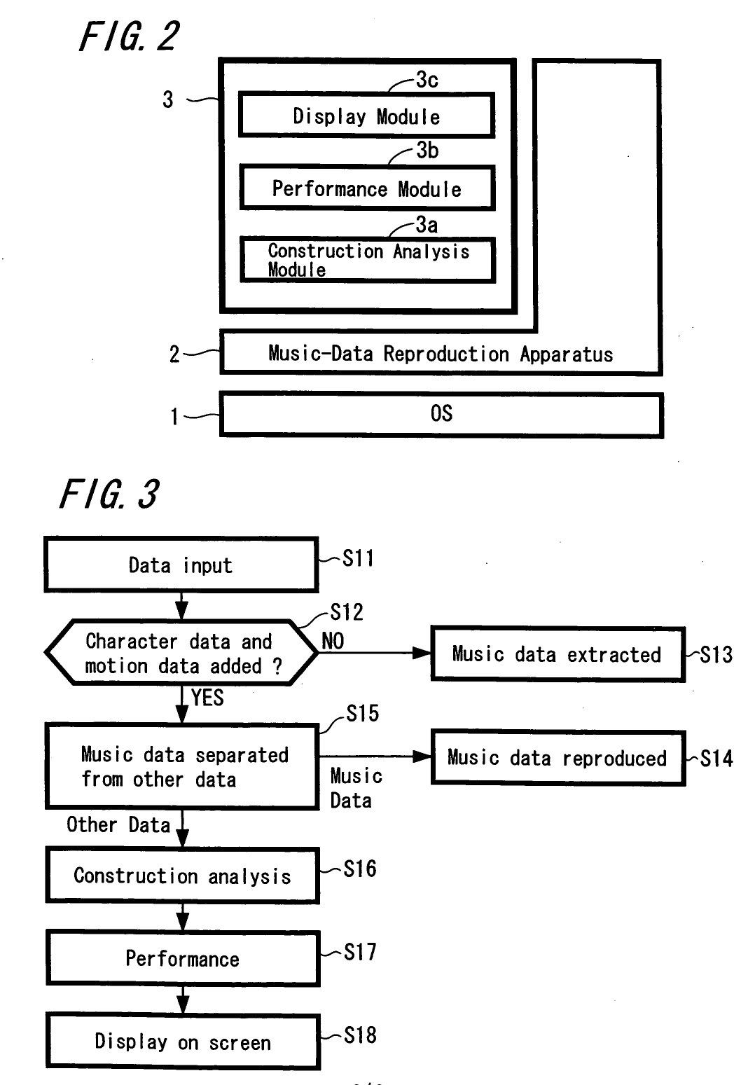

When the audio reproduction apparatus in this example configured as described above is seen from the processing of character data, a hierarchic structure as shown in FIG. 2 is conceivable. Specifically, the whole of the audio data reproduction apparatus 2 is controlled by OS (Operating System) 1 installed in the controller 24; when the audio reproduction is performed by the reproduction apparatus 2, if character data is added to audio data, processing on the character data is performed by a character engine 3 including the data processor 13, character-data processor 21, image processor 22, display panel 23 and the like. The character engine 3 includes a construction analysis module 3a, a performance module 3b, and a display module 3c.

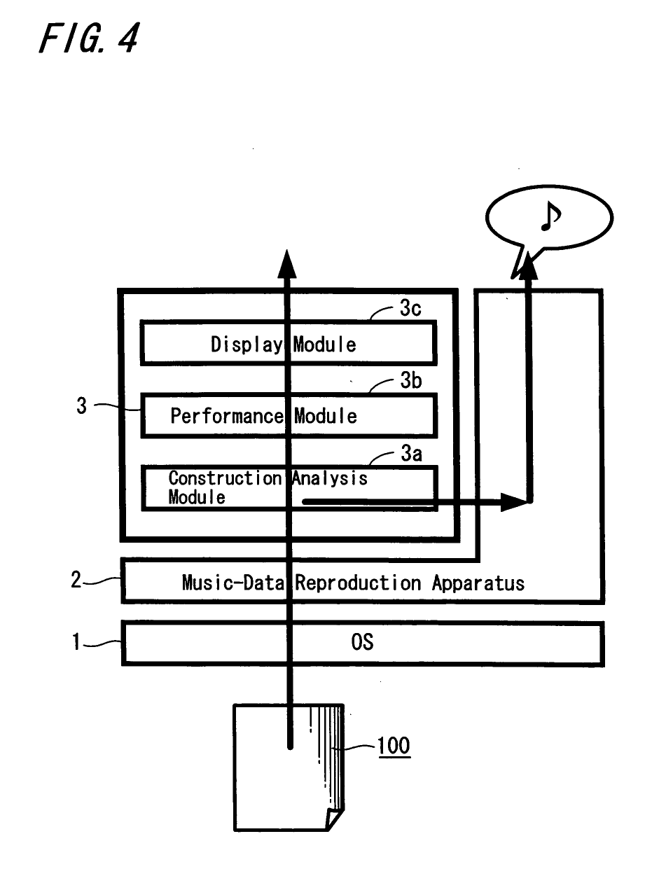

FIG. 3 is a flowchart showing the flow of data processing in audio reproduction apparatus of this example. First, when audio data is read out from the recording medium 11 (step S11), the controller 24 judges whether or not the character data and motion data are added to the audio data read (step S12). When it is judged that the character data and motion data are not added, only the audio data read out from the recording medium 11 (step S13) is extracted to perform reproduction processing to be output from the speakers 17L and 17R (step S14). When it is judged that the character data and motion data are added in step S12, processing of separating audio data from the other data (character data and motion data) is performed (step S15) and reproduction processing is performed with respect to the separated audio data in the following step S14.

Then, the character data and motion data separated in step S15 are subjected to construction analysis (step S16), and image processing for generating an image based on the analyzed construction is performed (step S17) and the generated image is displayed on the display panel (step S18).

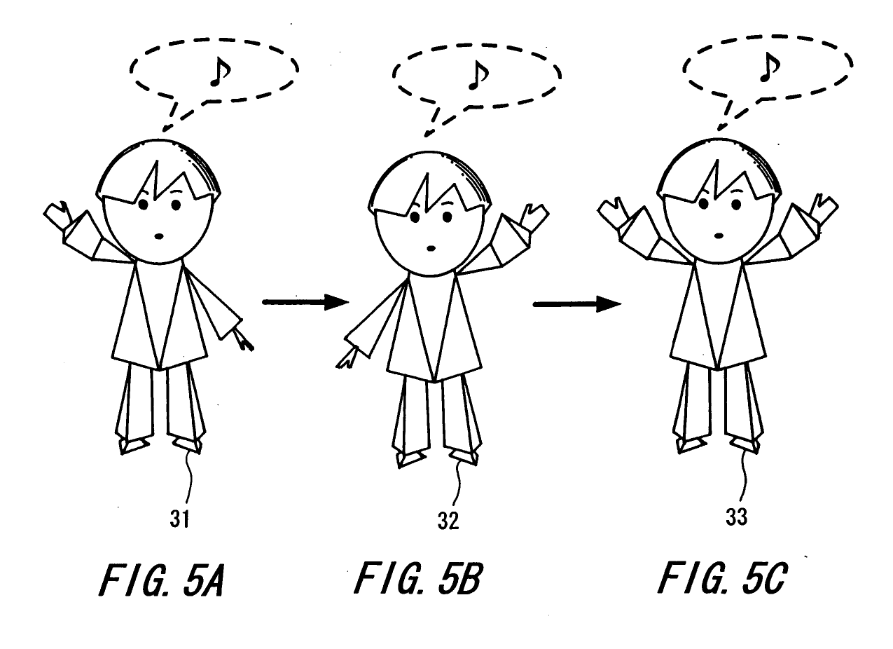

FIG. 4 shows an example of the processing state: when audio data 100 including the character data and motion data is processed to be reproduced, the character data is separated from the audio data in a section functioning as the construction analysis module 3a, and the performance module 3b and display module 3c perform processing on the data judged as the character data to be displayed as the character. With respect to the character data and motion data, the construction analysis module 3a performs processing of changing the internal data structure into an easy-to-handle form for the performance module. The processed character data is expressed as a connection between a joint and regions in a manner that corresponds to the structure of human body. The motion data may be described with relative values of a local coordinate system of various joints, or may be described with absolute values of a world coordinate system of character data itself. Processing of moving the character by the motion data is carried out to be linked with the audio reproduction.

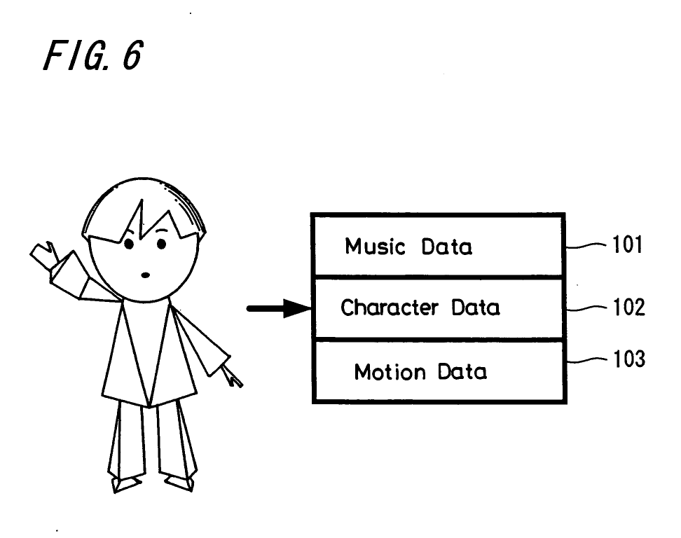

FIG. 5 shows an example of images in a state displayed. In case of this example, a character such as a person created based on the character data is displayed on a display panel as shown in FIGS. 5A, 5B and 5C. In this example, with instructions on character's motion in motion data, as is shown in FIG. 5A, a state in which the character raises one hand is displayed at a certain position in music reproduction, when the music reproduction proceeds from that state, the display changes to a state in which one hand of the character falls and the other hand is raised as shown in FIG. 5B. When the music reproduction further proceeds from that state, the display changes to a state in which both hands of the character are raised as shown in FIG. 5C.

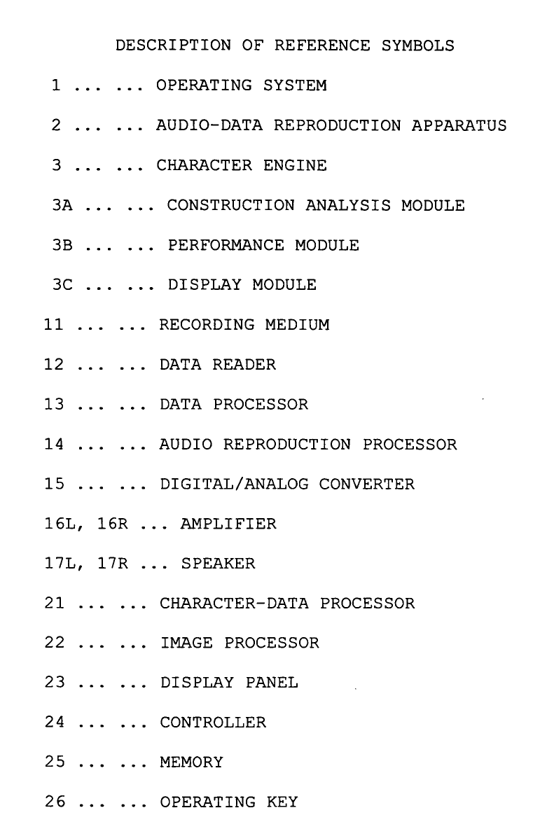

The character data and motion data for such display have the structure shown in FIG. 6, for example. Specifically, for example, audio data (music data) 101, character data 102, and motion data 103 constitute one audio data file. In this case, some flag, for example, is put to audio data to indicate that the character data and motion data are added. In addition, the character data 102 is data on the shape of each part of the displayed character. The motion data 103 indicates a coordinate position to be changed with respect to a part (here, an arm part, for example) at a specific position of the character at a specific time of audio reproduction. The motion data 103 shown in FIG. 6 is expressed in three-dimensional graphic description language called VRML (Virtual Reality Modeling Language) as follows:

DEF arm Orientation Interpolator[

Key[0.0000, 0.3000, 0.9000, 1.0000,]

Key Value[

0.0000 0.0000 0.0000 0.0000,
−1.0000 0.0000 0.0000 1.8256,
−1.0000 0.0000 0.0000 1.8256,
0.0000 0.0000 0.0000 0.0000,]}

Further, an example in which the audio data, character data and motion data are packed into a piece of data is expressed in an actual data form as follows:

Content-Type: multipart/mixed;

Boundary= “----=Next Part 000 0011 01BFA9E7.2EE28580”

----=Next part 000 0011 01BFA9E7.2EE28580
Content-Type: application/ATRAC3
music data
----=Next Part 000 0011 01BFA9E7.2EE28580
Content-Type: data/character
character data
----=Next Part 000 0011 01BFA9E7.2EE28580
Content-Type: data/motion
motion data
----=Next Part 000 0011 01BFA9E7.2EE28580--
---=Next Part (wed Apr 19 11:42:48 2000 705)----

With the character data and motion data having the above structure being added to audio data when reproducing the audio, such a character is displayed on the display panel that has motion corresponding to the audio reproduction. Being displayed in this manner, for example, if there is choreography corresponding to the reproduced music, the choreography will be indicated with the display of the character, and so the choreography can be studied by looking at the display.

Since the character thus displayed is based on data added to audio data itself, it is possible to change the displayed character and motion in accordance with music to be reproduced, and the character suitable for each music piece can be displayed. Differently from the case of an image program for reproducing a movie and the like, because no image signal for reproducing a moving image is prepared, the data volume is very small, and therefore, such a recording medium for the audio data that has almost the same recording capacity as that of a recording medium for ordinary audio data can be used. Moreover, differently from the case of a typical image program, even after contents have been produced, data (character data, motion data) for displaying an image is easily modified and, for example, modification of a motion of a character and the like can simply be performed afterward.

In addition, when the character data added to audio data is data for displaying a person and the like in three dimensional shape, by indicating a point of view (view angle) toward the displayed character with an operation of the key 26 and the like in the reproduction apparatus, the character seen from an arbitrary viewpoint can be displayed on the display panel 23.

1. An audio reproduction method when reproducing audio data to which character data for displaying a character having a specific shape is added, comprising the steps of:
generating data on an image having the shape specified by said character data by analyzing the character data, and
displaying the generated image data correspondingly to the reproduction of said audio data.

2. An audio reproduction method according to claim 1,
wherein when motion data for indicating motion of the character having the shape specified by said character data is further added to said audio data, the motion indicated by the motion data is displayed correspondingly to the reproduction of said audio data.

3. An audio reproduction method according to claim 1,
wherein said character data is data on a character having a three-dimensional shape, and based on a predetermined input operation the character to be displayed is made into a character having a shape seen from an arbitrary viewpoint.

4. An audio reproduction apparatus comprising:
retaining means for retaining audio data to which character data for displaying a character having a specific shape is added,
audio reproducing means for processing to reproduce the audio data retained in said retaining means,
image processing means for generating data on an image having the shape specified by the character data by analyzing the character when character data is added to the audio data reproduced in said audio reproducing means, and
display means for displaying image data generated in said image processing means correspondingly to the reproduction in said audio reproducing means.

5. An audio reproduction apparatus according to claim 4,
wherein motion data for indicating motion of the character having the shape specified by said character data is further added to the audio data retained in said retaining means, and
said image processing means generates an image in which the motion indicated by said motion data is added to the character specified by said character data.

6. An audio reproduction apparatus according to claim 4,
wherein the character data added to the audio data retained in said retaining means is data on a character having a three-dimensional shape,
operating means for indicating a viewpoint toward the character having a three-dimensional shape is provided, and
based on the viewpoint indicated by said operating means, the image data generated in said image processing means is made into an image of a character seen from the viewpoint.
